(19) United States
(12) Patent Application Publication
(10) Pub. No.: US 2011/0050778 A1
(43) Pub. Date: Mar. 3, 2011

(54) INK JET RECORDING APPARATUS AND SHEET FEEDING METHOD OF INK JET RECORDING APPARATUS

(75) Inventors: Satoshi Kaiho, Kanagawa-ken (JP); Masashi Hiroki, Kanagawa-ken (JP); Atsushi Kubota, Shizuoka-ken (JP); Kazuhiko Ohtsu, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/861,252

(22) Filed: Aug. 23, 2010

Related U.S. Application Data
(60) Provisional application No. 61/238,753, filed on Sep. 1, 2009.

(51) Int. Cl. B41J 29/38; B41J 2/01

(52) U.S. Cl. 347/16; 347/104

(57) ABSTRACT

According to one embodiment, an ink jet recording apparatus includes a first ink jet head, a second ink jet head, a main feeding passage, a first roundabout feeding passage, and a controller. The first ink jet head forms an image on a medium. The second ink jet head forms an image on the medium. The main feeding passage feeds the medium so that the first ink jet head and the second ink jet head form an image on the medium. The first roundabout feeding passage feeds the medium without allowing the medium to face the first ink jet head. The controller controls so as to feed the medium through the first roundabout feeding passage if the first ink jet head is unusable.

### CROSS-REFERENCE TO RELATED APPLICATION

This application is based upon and claims the benefit of priority from Provisional Application No. 61/238,753 filed on Sep. 1, 2009, the entire contents of which are incorporated herein by reference.

### FIELD

Embodiments described herein relate generally to an ink jet recording apparatus which ejects ink or the like through an ink jet head to form an image on a medium.

### BACKGROUND

Conventionally, an ink jet recording apparatus which forms an image using a head for ink ejection has the function of cleaning a nozzle surface in order to prevent non-ejection of ink from the head.

Further, there was used a type of ink jet recording apparatus that is provided with an image forming unit including a plurality of heads on a continuous feeding passage. In such an ink jet recording apparatus, when non-ejection of ink from any head is detected during image formation, an image forming operation of the entire apparatus should be stopped in order to clean a nozzle surface. In addition, in such an ink jet recording apparatus, the stop time of the image forming operation is lengthened as the number of cleanings of the nozzle surface increases. Thus, such an ink jet recording apparatus has the problem of lowering user convenience.

### BRIEF DESCRIPTION OF THE DRAWINGS

FIG. 1 is an exemplary lateral section view illustrating an ink jet recording apparatus according to an embodiment.

FIG. 2 is an exemplary lateral section view illustrating an ink jet recording apparatus according to an embodiment.

FIG. 3 is an exemplary lateral section view illustrating an ink jet recording apparatus according to an embodiment.

FIG. 4 is an exemplary diagram illustrating detection of non-ejection of ink according to an embodiment.

FIG. 5 is an exemplary block diagram illustrating a control system of an ink jet recording apparatus according to an embodiment.

FIG. 6 is an exemplary flowchart illustrating a single-side image formation in an ink jet recording apparatus according to an embodiment.

FIG. 7 is an exemplary flowchart illustrating a double-side image formation in an ink jet recording apparatus according to an embodiment.

### DETAILED DESCRIPTION

In general, according to one embodiment, an ink jet recording apparatus includes a first ink jet head, a second ink jet head, a main feeding passage, a first roundabout feeding passage, and a controller. The first ink jet head forms an image on a medium. The second ink jet head forms an image on the medium. The main feeding passage feeds the medium so that the first ink jet head and the second ink jet head form an image on the medium. The first roundabout feeding passage feeds the medium without allowing the medium to face the first ink jet head. The controller controls so as to feed the medium through the first roundabout feeding passage if the first ink jet head is unusable.

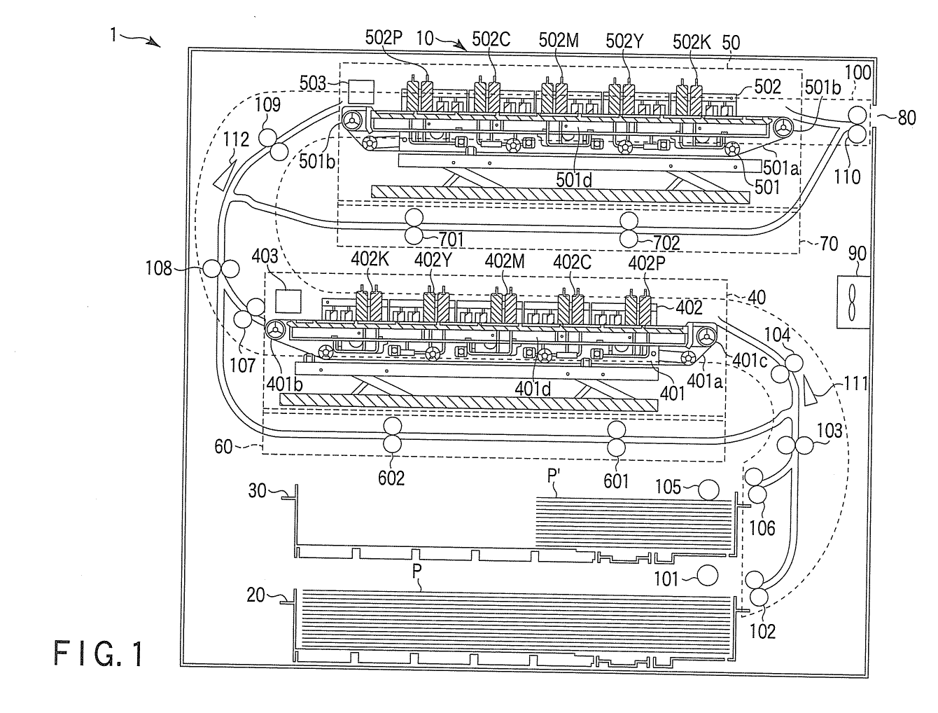

Hereinafter, an embodiment will be described with reference to the accompanying drawings. FIG. 1 is a lateral section view illustrating an ink jet recording apparatus 1 according to an embodiment. The ink jet recording apparatus 1 includes, inside a casing 10, a first cassette 20, a second cassette 30, a first image forming unit 40, and a second image forming unit 50. The first cassette 20 contains a bundle P including a plurality of sheets of mediums (papers). The second cassette 30 stores a bundle P′ including a plurality of sheets of mediums different in size from the medium contained in the first cassette 20. The first cassette 20 is disposed under the second cassette 30.

The first image forming unit 40 feeds the medium and forms an image. The second image forming unit 50 performs the same operation. The first image forming unit 40 is disposed above the second cassette 30. The second image forming unit 50 is disposed above the first image forming unit 40. Further, the ink jet recording apparatus 1 includes therein a first roundabout feeding passage 60 and a second roundabout feeding passage 70. In the casing 10 is installed a discharge port 80 which discharges the medium. A main feeding passage 100 is formed in a feeding path ranging from a medium supplying position of the first cassette 20 to the discharge port 80 via the first image forming unit 40 and the second image forming unit 50.

Next, a configuration of the first image forming unit 40 will be described. The first image forming unit 40 includes a feeding unit 401, a head mounting unit 402 and a maintenance unit 403. The feeding unit 401 includes a feeding belt 401a, a driving roller 401b, a driven roller 401c and a negative pressure chamber 401d. The feeding belt 401a extends over the driving roller 401b and the driven roller 401c in an endless manner. The feeding belt 401a operates depending upon the rotation of the driving roller 401b. In a surface of the feeding belt 401a are formed holes at a predetermined interval. In order to allow the medium to be held onto the feeding belt 401a, the negative pressure chamber 401d connected with a fan 90 is installed inside the feeding belt 401a.

The head mounting unit 402 includes an ink jet head 402P, an ink jet head 402C, an ink jet head 402M, an ink jet head 402Y and an ink jet head 402K, in order from the upstream side of a feeding direction of the medium. The head mounting unit 402 is disposed above the medium feeding unit 401. The ink jet head 402P ejects a preprocessing solution. The ink jet head 402C ejects a cyan toner. The ink jet head 402M ejects a magenta toner. The ink jet head 402Y ejects a yellow toner. The ink jet head 402K ejects a black toner. The head mounting unit 402 is also referred to as a first ink jet head.

In each of the ink jet heads 402P, 402C, 402M, 402Y and 402K, nozzles which eject ink droplets are arranged along a widthwise direction of the medium with a predetermined resolution. In each of the ink jet heads 402P, 402C, 402M, 402Y and 402K, the nozzles are arranged in a direction perpendicular to the feeding direction of the medium by the feeding belt 401a.

Each of the ink jet heads 402P, 402C, 402M, 402Y and 402K ejects ink droplets of each color in synchronization with the feeding operation of the medium by feeding belt 401a. Thus, the ink jet heads 402P, 4020, 402M, 402Y and 402K form a color image in a desired position of a surface of the medium.

The maintenance unit 403 performs maintenance for each nozzle surface whenever the image forming operation through the ink jet heads 402P, 402C, 402M, 402Y and 402K terminates. Further, if a nozzle surface of any one of the ink jet heads 402P, 402C, 402M, 402Y and 402K is in a state where the nozzle surface cannot eject ink, even though a printing request is made, the maintenance unit 403 maintains the nozzle surface.

Next, a configuration of the second image forming unit 50 will be described. The second image forming unit 50 includes a medium feeding unit 501, a head mounting unit 502 and a maintenance unit 503. The head mounting unit 502 is also referred to as a second ink jet head. The feeding unit 501 includes a feeding belt 501a, a driving roller 501b, a driven roller 501c and a negative pressure chamber 501d. The feeding belt 501a, the driving roller 501b, the driven roller 501c and the negative pressure chamber 501d each have the same configuration as the feeding belt 401a, the driving roller 401b, the driven roller 401c and the negative pressure chamber 401d as described above, and thus detailed description thereof will be omitted.

The head mounting unit 502 includes an ink jet head 502P, an ink jet head 502C, an ink jet head 502M, an ink jet head 502Y and an ink jet head 502K, in the order from the upstream side of the feeding direction of the medium. The ink jet head 502P, the ink jet head 502C, the ink jet head 502M, the ink jet head 502Y and the ink jet head 502K each have the same configuration as the ink jet head 402P, the ink jet head 402C, the ink jet head 402M, the ink jet head 402Y and the ink jet head 402K as described above, and thus detailed description thereof will be omitted. The maintenance unit 503 has the same configuration as the above-described maintenance unit 403, and thus detailed description thereof will be omitted.

In this respect, the operation of the first image forming unit 40 and the second image forming unit 50, and mainly, the maintenance operation for the nozzle surface is disclosed in a copending, commonly owned application entitled “IMAGE FORMING APPARATUS AND EJECTION LIQUID CIRCULATING METHOD” having application Ser. No. 12/707,810, which is incorporated herein by reference.

Next, the feeding path of the medium in the ink jet recording medium 1 will be described. Here, it is assumed that the first image forming unit 40 and the second image forming unit 50 are normal (usable) and images are to be formed on the both surfaces of the medium. A first medium supplying roller 101 extracts the medium corresponding to a selected size from the top of the bundle P contained in the first cassette 20 sheet by sheet and feeds the medium through a pair of feeding rollers 102, a pair of feeding rollers 103 and a pair of first register rollers 104 in the order. Similarly, a second medium supplying roller 105 extracts the medium corresponding to a selected size from the bundle P′ contained in the second cassette 30 sheet by sheet and feeds the medium through a pair of first feeding rollers 106, the pair of feeding rollers 103 and the pair of first register rollers 104 in that order. The pair of first register rollers 104 supplies the medium to the first image forming unit 40. The feeding belt 401a feeds the medium from the upstream side on which the ink jet head 4029 is installed towards the downstream side on which the ink jet head 402K is installed. That is, the feeding belt 401a serves as the feeding path of the medium. The first image forming unit 40 forms a full color image on an upper surface of the medium.

A pair of feeding rollers 107 feeds the medium image-formed on one surface thereof in the first image forming unit 40 through a pair of feeding rollers 108 and a pair of second register rollers 109 in the order. The pair of second register rollers 109 supplies the medium to the second image forming unit 50. Here, the pair of feeding rollers 107, the pair of feeding rollers 108 and the pair of second register rollers 109 supply the medium to the feeding belt 501a so that a surface of the medium reverse to the surface image-formed in the first image forming unit 40 becomes an upper surface. The feeding belt 501a feeds the medium from the upstream side on which the ink jet head 502P is installed towards the downstream side on which the ink jet head 502K is installed. That is, the feeding belt 501a serves as the feeding path of the medium. The second image forming unit 50 forms a full color image on the upper surface (surface reverse to the surface image-formed in the first image forming unit 40) of the medium. A pair of feeding rollers 110 discharges the medium image-formed in the second image forming unit 50 to the outside of the casing 10 through the discharge port 80. In this respect, when the image is to be formed only on one surface of the medium, the ink jet recording apparatus 1 can form the image on the medium through any one of the first image forming unit 40 and the second image forming unit 50.

Next, the first roundabout feeding passage 60 will be described. One end of the first roundabout feeding passage 60 is connected with the main feeding passage 100 which feeds the medium to the first image forming unit 40, in a downstream position in the feeding direction of the pair of feeding rollers 103 which feeds the medium extracted from the second cassette 30 disposed on the most upstream side of the feeding direction. The first flapper 111 is installed around the one end of the first roundabout feeding passage 60. The other end of the first roundabout feeding passage 60 is connected with the main feeding passage 100 which feeds the medium output from the first image forming unit 40, in a downstream position of the feeding direction of the first image forming unit 40. The first roundabout feeding passage 60 is installed in parallel under the first image forming unit 40. Next, the second roundabout feeding passage 70 will be described. One end of the second roundabout feeding passage 70 is connected with the main feeding passage 100 which feeds the medium to the second image forming unit 50, in a downstream position of the feeding direction of the other end of the first roundabout feeding passage 60. The second flapper 112 is installed around the one end of the second roundabout feeding passage 70. The other end of the second roundabout feeding passage 70 is connected with the main feeding passage 100 which feeds the medium output from the second image forming unit 50, in a downstream position of the feeding direction of the second image forming unit 50. The second roundabout feeding passage 70 is installed in parallel under the second image forming unit 50.

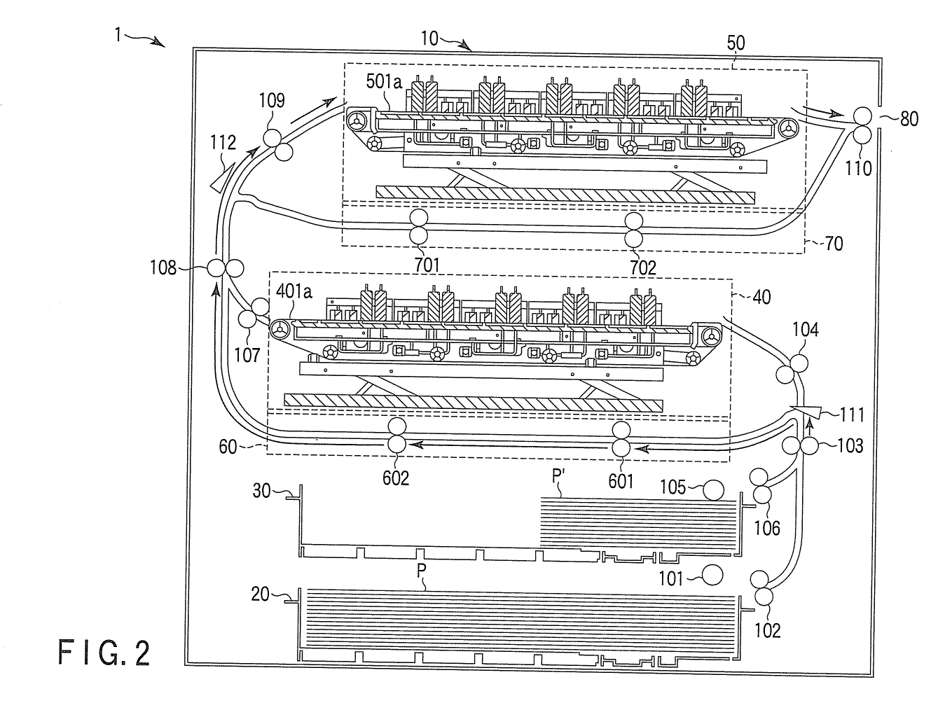

Next, a case where the second image forming unit 50 forms an image on one surface of the medium when the first image forming unit 40 is under maintenance (unusable) will be described. FIG. 2 illustrates a medium feeding path of the medium in this case. The first flapper 111 is switched so that the medium is fed through any one of the pair of first register rollers 104 or the first roundabout feeding passage 60. The medium supplied to the first roundabout feeding passage 60 is supplied to the pair of feeding rollers 108 without being image-formed in the first image forming unit 40. The first roundabout feeding passage 60 feeds the medium from the side on which the first flapper 111 is installed toward the side on which the pair of feeding rollers 108 is installed, for example, using a pair of feeding rollers 601 and a pair of feeding rollers 602. Accordingly, the pair of feeding rollers 103 feeds the medium to the first roundabout feeding passage 60 by the first flapper 111, not to the pair of first resist roller 104. The pair of feeding rollers 601 and the pair of feeding rollers 602 feed the medium, which is not image-formed in the first image forming unit 40, to the pair of feeding rollers 108.

Further, the second flapper 112 is switched so that the medium is fed to any one of the second image forming unit 50 and the second roundabout feeding passage 70. The medium supplied to the second roundabout feeding passage 70 is supplied to the pair of feeding rollers 110 without being image-formed in the second image forming unit 50. The second roundabout feeding passage 70 feeds the medium from the side on which the second flapper 112 is installed toward the side on which the pair of feeding rollers 110 is installed, for example, using a pair of feeding rollers 701 and a pair of feeding rollers 702. Accordingly, the pair of second register rollers 109 supplies the medium to the second image forming unit 50 by the second flapper 112. The second image forming unit 50 forms a full color image on the upper surface of the medium. The pair of feeding rollers 110 discharges the medium image-formed on one surface thereof in the second image forming unit 50 to the outside of the casing 10 through the discharge port 80.

Further, when the second image forming unit 50 is to form an image on the both surfaces of the medium, the medium is fed through a path as will be described below. The pair of feeding rollers (switchback unit) 110 feeds (switches back) the medium image-formed on one surface thereof in the second image forming unit 50, as described above, in the direction opposite to the discharging direction. That is, the pair of feeding rollers 110 feeds the medium to the second roundabout feeding passage 70. The pair of feeding rollers 702 and the pair of feeding rollers 701 supply the medium to the pair of second register rollers 109. The pair of second register rollers 109 supplies the medium to the second image forming unit 50 once again. The upper surface of the medium on the feeding belt 501a is a surface reverse to the surface previously image-formed in the second image forming unit 50. That is, the second image forming unit 50 can independently form images on the both surfaces of the medium by the second roundabout feeding passage 70. Then, the pair of feeding rollers 110 discharges the medium image-formed on the both surfaces thereof in the second image forming unit 50 to the outside of the casing 10 through the discharge port 80.

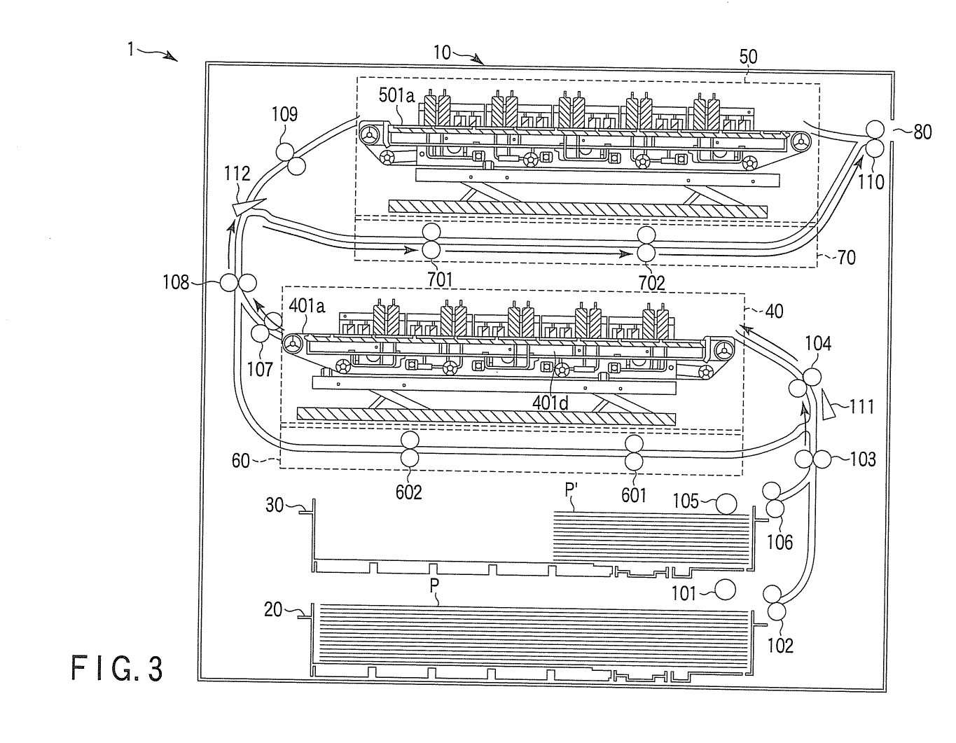

Next, a case where the first image forming unit 40 forms an image on one surface of the medium when the second image forming unit 50 is under maintenance will be described. FIG. 3 illustrates a medium feeding path in this case.

The pair of feeding rollers 103 feeds the medium to the pair of first register rollers 104 by the first flapper 111. The first image forming unit 40 forms a full color image on the upper surface of the medium. The pair of feeding rollers 107 feeds the medium image-formed on one surface thereof in the first image forming unit 40 to the pair of feeding rollers 108. The pair of feeding rollers 108 feeds the medium through the second roundabout feeding passage 70 by the second flapper 112, not to the second image forming unit 50. The pair of feeding rollers 701 and the pair of feeding rollers 702 feed the medium image-formed in the first image forming unit 40 to the pair of feeding rollers 110. The pair of feeding rollers 110 discharges the medium image-formed on one surface thereof in the first image forming unit 40 to the outside of the casing 10 through the discharge port 80.

Further, when the first image forming unit 40 is to form images on the both surfaces of the medium, the medium is fed through a path which will be described below. The pair of feeding rollers (switchback unit) 108 feeds (switches back) the medium image-formed on one surface thereof in the first image forming unit 40, as described above, in the direction opposite to the discharging direction. That is, the pair of feeding rollers 108 feeds the medium image-formed in the first image forming unit 40 to the first roundabout feeding passage 60. The pair of feeding rollers 602 and the pair of feeding rollers 601 supply the medium to the pair of first register rollers 104. The pair of first register rollers 104 supplies the medium to the first image forming unit 40 once again. The upper surface of the medium on the feeding belt 401a is a surface reverse to the surface previously image-formed in the first image forming unit 40. That is, the first image forming unit 40 can independently form images on the both surfaces of the medium by the first roundabout feeding passage 60. Then, the medium image-formed on the both surfaces thereof in the first image forming unit 40 is discharged to the outside of the casing 10 through the discharge port 80, via the second roundabout feeding passage 70.

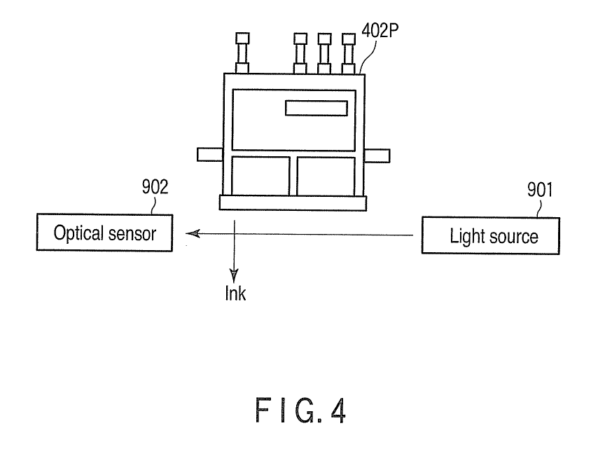

FIG. 4 illustrates a detection mechanism which detects non-ejection of ink from the nozzle surface of the ink jet head 402P. The head mounting unit 402 includes a light source 901 and an optical sensor 902. The light source 901 and the optical sensor 902 are installed under the ink jet head 402P so as to coincide with an arrangement direction of the nozzles. The optical sensor 902 detects non-ejection of ink from the nozzle surface according to a detected level of light emitted from the light source 901. The light source 901 and the optical sensor 902 detect the presence or absence of non-ejection for every nozzle of the ink jet head 402P through pre-ejection during, before or after image formation. Further, the detection mechanism may be a mechanism which detects a disconnection of an ejection heater of the ink jet head 402P, or may be a mechanism which electrically detects the ink ejection on the side facing the nozzle surface.

If the optical sensor 902 detects non-ejection of ink from any one of the nozzles of the ink jet head 402P, the maintenance unit 403 moves to a position facing the ink jet head 402P and maintains the nozzle surface. Hereinbefore, the description was made for the ink jet head 402P, but can be similarly applied to the ink jet heads 402C, 402M, 402Y and 402K. The head mounting unit 402 is independently provided with the detection mechanism including the light source 901 and the optical sensor 902 for every ink jet head. Further, the second image forming unit 50 has the same detection mechanism as described above.

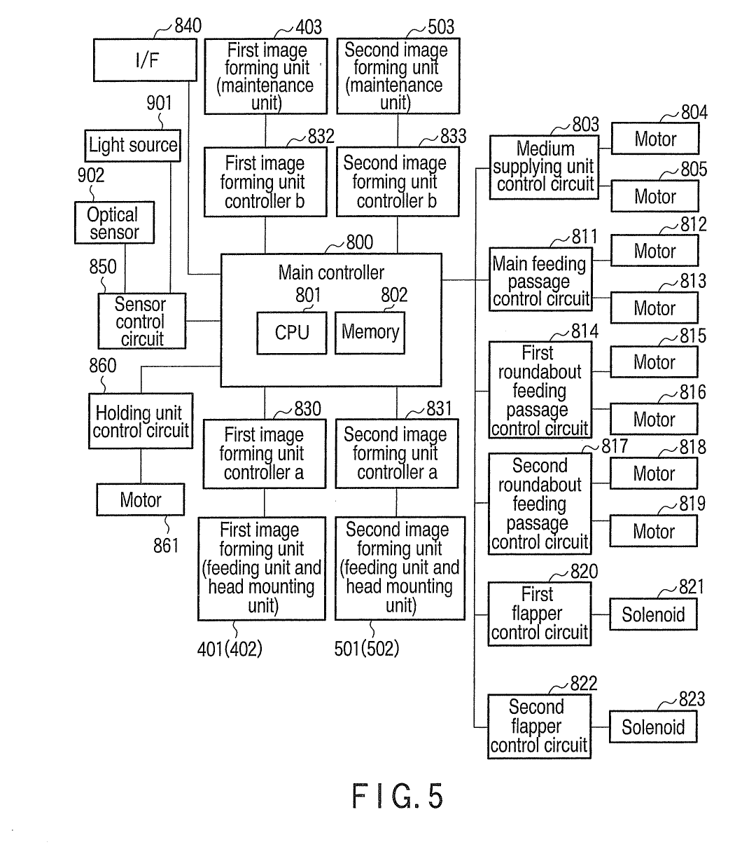

FIG. 5 is a block diagram illustrating a control system of the ink jet recording apparatus 1 according to the embodiment. The ink jet recording apparatus 1 includes a main controller 800, a CPU 801, a memory 802, a medium supplying unit control circuit 803, a motor 804, a motor 805, a main feeding passage control circuit 811, a motor 812, a motor 813, a first roundabout feeding passage control circuit 814, a motor 815, a motor 816, a second roundabout feeding passage control circuit 817, a motor 818, a motor 819, a first flapper control circuit 820, a solenoid 821, a second flapper control circuit 822, a solenoid 823, a first image forming unit controller a 830, a second image forming unit controller a 831, a first image forming unit controller b 832, a second image forming unit controller b 833, an I/F 840, a sensor control circuit 850, an holding unit control circuit 860, and a motor 861.

The main controller 800 is a microcomputer including the CPU 801 which is a processor and the memory 802. The CPU 801 performs a variety of operations according to programs stored in the memory 802. The CPU 801 outputs control signals to the respective elements.

The medium supplying unit control circuit 803 controls the driving of a plurality of motors including the motors 804 and 805. The motor 804 drives the pair of first register rollers 104. The motor 805 drives the pair of second register rollers 109. The main feeding passage control circuit 811 controls the driving of a plurality of motors including the motors 812 and 813. The motor 812 drives the pair of feeding rollers 108. The pair of feeding rollers 108 can feed the medium in a bi-directional manner under the control of the main feeding passage control circuit 811. The motor 813 drives the pair of feeding rollers 110. The pair of feeding rollers 110 can feed the medium in a bi-directional manner under the control of the main feeding passage control circuit 811.

The first roundabout feeding passage control circuit 814 controls the driving of a plurality of motors including the motors 815 and 816. The motor 815 drives the pair of feeding rollers 601. The motor 816 drives the pair of feeding rollers 602. The pair of feeding rollers 601 and the pair of feeding rollers 602 can feed the medium in a bi-directional manner under the control of the first roundabout feeding passage control circuit 814. The second roundabout feeding passage control circuit 817 controls the driving of a plurality of motors including the motors 818 and 819. The motor 818 drives the pair of feeding rollers 701. The motor 819 drives the pair of feeding rollers 702. The pair of feeding rollers 701 and the pair of feeding rollers 702 can feed the medium in a bi-directional manner under the control of the second roundabout feeding passage control circuit 817. The first flapper control circuit 820 controls the driving of the solenoid 821. The solenoid 821 drives the first flapper 111. The second flapper control circuit 822 controls the driving of the solenoid 823. The solenoid 823 drives the second flapper 112.

The first image forming unit controller a 830 controls the operations of the feeding unit 401 and the head mounting unit 402 of the first image forming unit 40. The second image forming unit controller a 831 controls the operations of the feeding unit 501 and the head mounting unit 502 of the second image forming unit 50. The first image forming unit controller b 832 controls the operation of the maintenance unit 403 of the first image forming unit 40. The first image forming unit controller b 832 controls the maintenance unit 403 to move to the position facing the nozzle surface of the ink jet heads 402P, 402C, 402M, 402Y and 402K mounted on the head mounting unit 402 and to maintain the nozzle surface. The second image forming unit controller b 833 controls the operation of the maintenance unit 503 of the second image forming unit 50. The second image forming unit controller b 833 similarly controls the maintenance unit 503 to move to the position facing the nozzle surface of the ink jet heads 502P, 502C, 502M, 502Y and 502K mounted on the head mounting unit 502 and to maintain the nozzle surface.

The I/F 840 is connected with an external computer (not shown). The I/F 840 receives input of a printing request and an image signal transmitted from the external computer to the ink jet recording apparatus 1. The sensor control circuit 850 controls the operations of the light source 901 and the optical sensor 902. The sensor control circuit 850 outputs the detection result of the optical sensor 902 to the main controller 800. The holding unit control circuit 860 controls the driving of the motor 861. The motor 861 drives the fan 90.

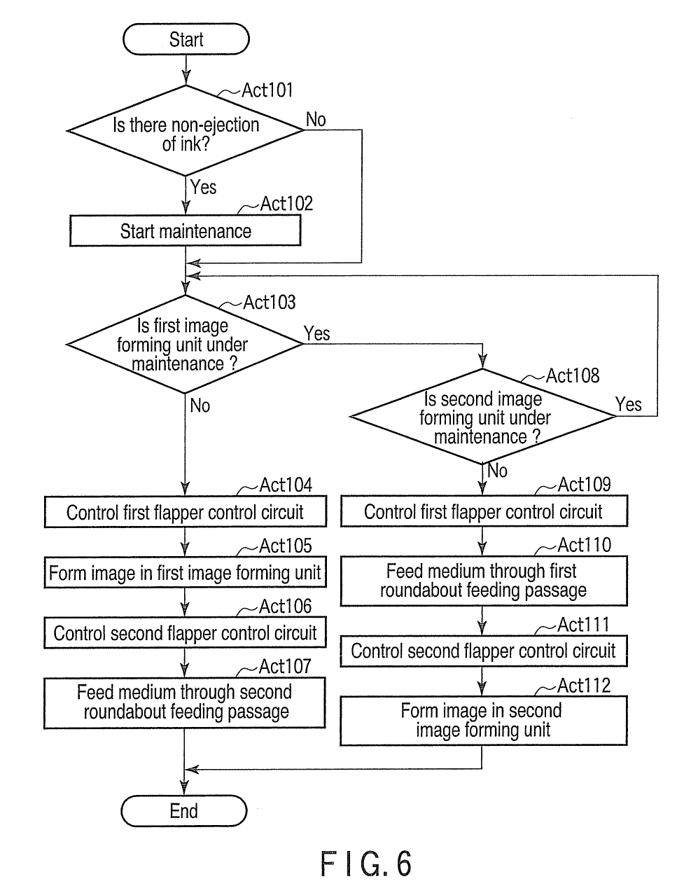

Next, the operation of the ink jet recording apparatus 1 when the image is formed on one surface of the medium will be described. FIG. 6 is a flowchart illustrating the operation of the ink jet recording apparatus 1 in this case. Firstly, the main controller 800 detects whether there is non-ejection of ink from each ink jet head mounted on the head mounting unit 402 and the head mounting unit 502, through the light source 901 and the optical sensor 902 (Act 101). If the main controller 800 detects non-ejection of ink in the head mounting unit 402 or the head mounting unit 502 (YES in Act 101), the corresponding image forming unit controller drives the corresponding maintenance unit (Act 102). Here, if the corresponding image forming unit controller is the first image forming unit controller b 832, the maintenance unit 403 is driven to start the maintenance for the nozzle surface of the ink jet heads 402P, 402C, 402M, 402Y and 402K mounted on the head mounting unit 402. If the corresponding image forming unit controller is the second image forming unit controller b 833, the second image forming unit controller b 833 similarly drives the maintenance unit 503 to start the maintenance for the nozzle surface of the ink jet heads 502P, 502C, 502M, 502Y and 502K mounted on the head mounting unit 502.

The main controller 800 determines whether the first image forming unit 40 is under maintenance under the condition that a printing request is received (Act 103). If the first image forming unit 40 is not under maintenance (NO in Act 103), the main controller 800 gives an instruction to the first flapper control circuit 820 so that the medium is fed to the first image forming unit 40 using the first flapper 111 (Act 104). The main controller 800 gives an instruction to the first image forming unit controller a 830 so that an image is formed on the upper surface of the medium using the feeding unit 401 and the head mounting unit 402 of the first image forming unit 40 (Act 105).

The main controller 800 gives an instruction to the second flapper control circuit 822 so that the medium image-formed in the first image forming unit 40 is fed to the second roundabout feeding passage 70 using the second flapper 112 (Act 106). The main controller 800 gives an instruction to the second roundabout feeding passage control circuit 817 so that the medium is fed to the pair of feeding rollers 110 through the second roundabout feeding passage 70 (Act 107). The main controller 800 gives an instruction to the main feeding passage control circuit 811 so that the medium is discharged to the outside of the casing 10 through the discharge port 80. Further, if all of the first image forming unit 40 and the second image forming unit 50 are not under maintenance, the main controller 800 may give an instruction so that an image is formed on one surface of the medium in the second image forming unit 50. In this case, the main controller 800 may perform control so that the medium is fed through the roundabout feeding passage making a pair with the image forming unit which does not perform the image-formation. Alternatively, the main controller 800 may give an instruction to the main feeding passage control circuit 811 so that the medium is fed to the second image forming unit 50, not to the roundabout feeding passage.

If the main controller 800 determines that the first image forming unit 40 is under maintenance (YES in Act 103), the main controller 800 determines whether the second image forming unit 50 is under maintenance (Act 108). If it is determined that the second image forming unit 50 is not under maintenance (NO in Act 108), the main controller 800 gives an instruction to the first flapper control circuit 820 so that the medium is fed to the first roundabout feeding passage 60 using the first flapper 111 (Act 109). The main controller 800 gives an instruction to the first roundabout feeding passage control circuit 814 so that the medium is fed to the pair of feeding rollers 108 through the first roundabout feeding passage 60 using the pair of feeding rollers 601 and the pair of feeding rollers 602 (Act 110). In this way, it is possible to feed the medium to the downstream side of the head mounting unit 402 in the feeding direction without allowing the medium to face the head mounting unit 402.

The main controller 800 gives an instruction to the second flapper control circuit 822 so that the medium is fed to the second image forming unit 50 using the second flapper 112 (Act 111). The main controller 800 gives an instruction to the second image forming unit controller 831 so that an image is formed on the upper surface of the medium using the feeding unit 501 and the head mounting unit 502 of the second image forming unit 50 (Act 112). The main controller 800 gives an instruction to the main feeding passage control circuit 811 so that the medium image-formed on one surface thereof in the second image forming unit 50 is discharged to the outside of the casing 10 through the discharge port 80, using the pair of feeding rollers 110.

If the main controller 800 determines that the second image forming unit 50 is under maintenance (YES in Act 108), the main controller 800 waits until the maintenance for any one of the first image forming unit 40 and the second image forming unit 50 ends.

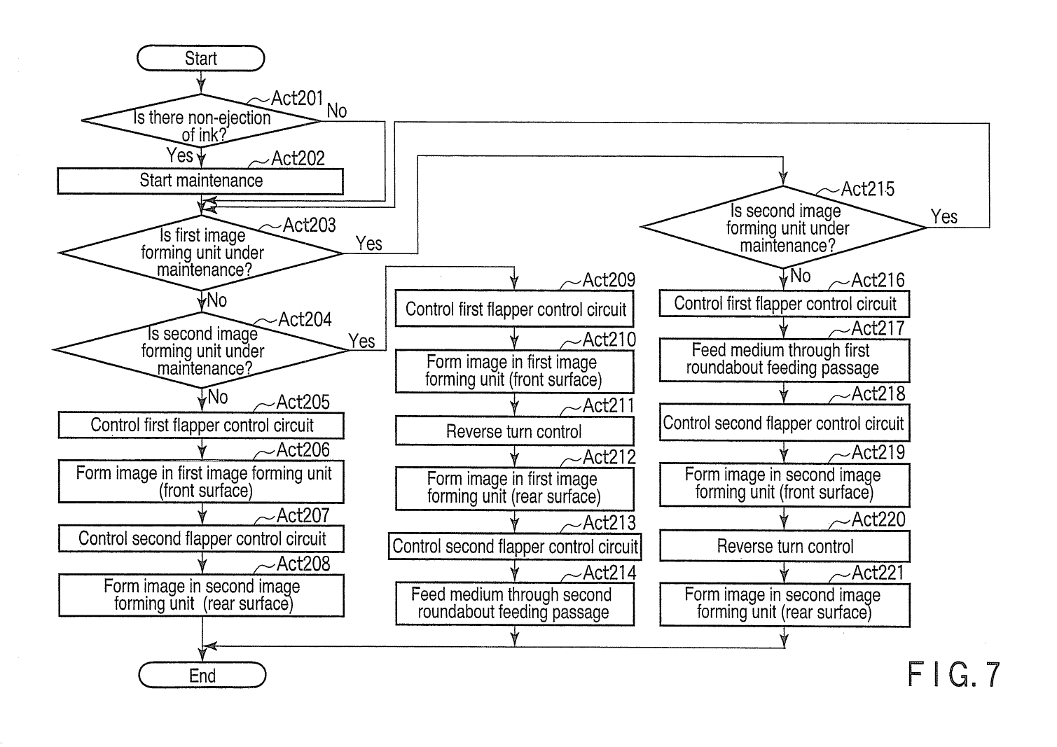

Next, the operation of the ink jet recording apparatus 1 when images are formed on the both surfaces of the medium will be described. FIG. 7 is a flowchart illustrating the operation of the ink jet recording apparatus 1 in this case. Acts 201 to 203 are the same as Acts 101 to 103, and thus description thereof will be omitted. Further, Acts 205 to 207 are the same as Acts 104 to 106, and thus description thereof will be omitted. After finishing Act 207, the main controller 800 gives an instruction to the second image forming unit controller a 831 so that an image is formed on the upper surface of the medium using the feeding unit 501 and the head mounting unit 502 of the second image forming unit 50 (Act 208).

If the main controller 800 determines that the second image forming unit 50 is under maintenance (YES in Act 204), the main controller 800 gives an instruction to the first flapper control circuit 820 so that the medium is fed to the first image forming unit 40 using the first flapper 111 (Act 209). The main controller 800 gives an instruction to the first image forming unit controller a 830 so that an image is formed on the upper surface (front surface) of the medium using the feeding unit 401 and the head mounting unit 402 of the first image forming unit 40 (Act 210). The main controller 800 controls the main feeding passage control circuit 811 so that the medium image-formed in the first image forming unit 40 is fed to the first roundabout feeding passage 60 using the pair of feeding rollers 108. The main controller 800 gives an instruction to the first roundabout feeding passage control circuit 814 so that the medium is fed to the pair of first register rollers 104 through the first roundabout feeding passage 60 using the pair of feeding rollers 601 and the pair of feeding rollers 602. Then, the main controller 800 gives an instruction to the medium supplying unit control circuit 803 so that the medium is supplied to the first image forming unit 40 once again using the pair of first register rollers 104 (Act 211). That is, in the operation of Act 211, a reverse turn of the medium is instructed.

The main controller 800 controls the first image forming unit controller a 830 so that an image is formed on the upper surface (rear surface) of the medium using the feeding unit 401 and the head mounting unit 402 of the first image forming unit 40 (Act 212). The main controller 800 controls the second flapper control circuit 822 so that the medium image-formed on the both surfaces thereof in the first image forming unit 40 is fed to the second roundabout feeding passage 70 using the second flapper 112 (Act 213). The main controller 800 controls the second roundabout feeding passage control circuit 817 so that the medium is fed to the pair of feeding rollers 110 through the second roundabout feeding passage 70 using the pair of feeding rollers 701 and the pair of feeding rollers 702 (Act 214). The main controller 800 controls the main feeding passage control circuit 811 so that the medium image-formed on the both surfaces thereof in the first image forming unit 40 is discharged to the outside of the casing 10 through the discharge port 80 using the pair of feeding rollers 110.

If the main controller 800 determines that the first image forming unit 40 is under maintenance (YES in Act 203), the main controller 800 determines whether the second image forming unit 50 is under maintenance (Act 215). If the main controller 800 determines that the second image forming unit 50 is not under maintenance (NO in Act 215), the main controller 800 gives an instruction to the first flapper control circuit 820 so that the medium is fed to the first roundabout feeding passage 60 using the first flapper 111 (Act 216). The main controller 800 gives an instruction to the first roundabout feeding passage control circuit 814 so that the medium is fed to the pair of feeding rollers 108 through the first roundabout feeding passage 60 using the pair of feeding rollers 601 and the pair of feeding rollers 602 (Act 217).

The main controller 800 gives an instruction to the second flapper control circuit 822 so that the medium is fed to the second image forming unit 50 using the second flapper 112 (Act 218). The main controller 800 gives an instruction to the second image forming unit controller a 831 so that an image is formed on the upper surface (front surface) of the medium using the feeding unit 501 and the head mounting unit 502 of the second image forming unit 50 (Act 219). The main controller 800 gives an instruction to the main feeding passage control circuit 811 so that the medium image-formed in the second image forming unit 50 is fed to the second roundabout feeding passage 70 using the pair of feeding rollers 110. The main controller 800 gives an instruction to the second roundabout feeding passage control circuit 817 so that the medium is fed to the pair of second register rollers 109 through the second roundabout feeding passage 70 using the pair of feeding rollers 701 and the pair of feeding rollers 702 (Act 220). That is, in the operation of Act 220, a reverse turn of the medium occurs. The main controller 800 gives an instruction to the second image forming unit controller a 831 so that an image is formed on the upper surface (rear surface) of the medium using the feeding unit 501 and the head mounting unit 502 of the second image forming unit 50 (Act 221). The main feeding passage control circuit 811 performs control so that the medium image-formed on the both surfaces thereof in the second image forming unit 50 is discharged to the outside of the casing 10 through the discharge port 80 using the pair of feeding rollers 110. If the main controller 800 determines that the second image forming unit 50 is under maintenance (YES in Act 215), the main controller 800 waits until the maintenance for any one of the first image forming unit 40 and the second image forming unit 50 ends.

As described above, in the embodiment, the first roundabout feeding passage 60 is used when the first image forming unit 40 is under maintenance, but the first roundabout feeding passage 60 can be also used when the first image forming unit 40 is unusable due to malfunction or other causes. This is the same case with the second image forming unit 50. Further, the first roundabout feeding passage 60 is installed under the first image forming unit 40, but the position is not limited thereto. The first image forming unit 40 and the second image forming unit 50 may be disposed with the same height in the horizontal direction. The first roundabout feeding passage 60 has only to be installed so that the medium can be fed to the pair of feeding rollers 108 in order not to form images in the first image forming unit 40. For example, the first roundabout feeding passage 60 may be installed above the first image forming unit 40. The above modification of the first roundabout feeding passage 60 may be similarly applied to second roundabout feeding passage 70.

Further, as shown in FIG. 1, the downstream side of the first image forming unit 40 and the upstream side of the second image forming unit 50 are nearly the same positions in the widthwise direction. In addition, the upstream side of the first image forming unit 40 and the side on which the medium is discharged from the first cassette 20 and the second cassette 30 are nearly the same positions in the widthwise direction. Accordingly, the medium is fed inside the ink jet recording apparatus 1 in an “S” (zigzag) shape. Thus, the ink jet recording apparatus 1 can occupy a small installation area. Further, the first image forming unit 40 and the second image forming unit 50 are arranged in the vertical direction, but may be arranged in the horizontal direction.

According to the embodiment, even though non-ejection is detected in any one of ink jet head during printing, the printing can be continuously performed through the image forming unit which does not include the ink jet head. Thus, the ink jet recording apparatus 1 can secure an image quality through image formation without stopping the printing operation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ink jet recording apparatus comprising:
a first ink jet head which forms an image on a medium;
a second ink jet head which forms an image on the medium;
a main feeding passage which feeds the medium so that the first ink jet head and the second ink jet head form an image on the medium;
a first roundabout feeding passage which feeds the medium without allowing the medium to face the first ink jet head; and
a controller which controls so as to feed the medium through the first roundabout feeding passage if the first ink jet head is unusable.

2. The apparatus of claim 1, comprising:
a first maintenance unit which maintains an ink ejection from the first ink jet head.

3. The apparatus of claim 2, wherein the controller feeds the medium through the first roundabout feeding passage if the first maintenance unit operates.

4. The apparatus of claim 1, wherein the first roundabout feeding passage is disposed under the main feeding passage.

5. The apparatus of claim 1, comprising:
a first flapper which is disposed on an upstream side of the first ink jet head in a feeding direction and switches a passage so that the medium is fed to the first roundabout feeding passage.

6. The apparatus of claim 1, wherein the controller feeds the medium after completion of the image formation by the first ink jet head to the first roundabout feeding passage.

7. The apparatus of claim 6, wherein the controller controls so that a surface reverse to an image-formed surface of the medium after completion of the image formation faces the first ink jet head.

8. The apparatus of claim 1, comprising:
a second roundabout feeding passage which feeds the medium without allowing the medium to face the second ink jet head,
wherein the controller controls so as to feed the medium through the second roundabout feeding passage if the second ink jet head is unusable.

9. The apparatus of claim 8, comprising:
a second maintenance unit which maintains an ink ejection from the second ink jet head.

10. The apparatus of claim 9, wherein the controller feeds the medium through the second roundabout feeding passage if the second maintenance unit operates.

11. The apparatus of claim 8, wherein the second roundabout feeding passage is disposed under the main feeding passage.

12. The apparatus of claim 8, comprising:
a second flapper which is disposed on an upstream side of the second ink jet head and switches a passage so that the medium is fed to the second roundabout feeding passage.

13. The apparatus of claim 8, wherein the controller feeds the medium after completion of the image formation by the second ink jet head to the second roundabout feeding passage.

14. The apparatus of claim 13, wherein the controller performs control so that a surface reverse to an image-formed surface of the medium after completion of the image formation faces the second ink jet head.

15. The apparatus of claim 8, wherein the second ink jet head is disposed above the first ink jet head.

16. A medium feeding method used in an ink jet recording apparatus including first and second ink jet heads which form an image on a medium; a main feeding passage which feeds the medium so that the first and second ink jet heads form a image on the medium; a first roundabout feeding passage which feeds the medium without allowing the medium to face the first ink jet head, the method comprising:
determining whether or not the first ink jet head is usable; and
controlling so as to feed the medium through the first roundabout feeding passage if the first ink jet head is unusable.

17. The method of claim 16, wherein the first ink jet head is unusable during maintenance.

18. The method of claim 16, comprising:
switching the position of a first flapper so that the medium is fed to the first roundabout feeding passage.

19. The method of claim 16, wherein the ink jet recording apparatus further includes a second roundabout feeding passage which feeds the medium without allowing the medium to face the second ink jet head,
the method comprising:
determining whether or not the second ink jet head is usable; and
controlling so as to feed the medium through the second roundabout feeding passage if the second ink jet head is unusable.
